(19) United States
(12) Patent Application Publication
(10) Pub. No.: US 2011/0298754 A1
(43) Pub. Date: Dec. 8, 2011

(54) Gesture Input Using an Optical Input Device

(76) Inventors: Thomas Bove, Copenhagen K (DK); Michael Rahr, Roskilde (DK)

(21) Appl. No.: 13/133,265

(22) PCT Filed: Dec. 8, 2008
(86) PCT No.: PCT/EP08/67042

§ 371 Date: Aug. 22, 2011

(51) Int. Cl. G06F 3/042

(52) U.S. Cl. 345/175

(57) ABSTRACT

A method, an apparatus and a computer program, the method including detecting first information, indicating that a first action is to be performed, from an optical user input device, the first information being provided by the optical user input device in response to gesture input from a user; detecting further information from an input device; and using the further information to disambiguate, subsequent to detection of the first information, second information provided by the optical user input device to determine whether the second information indicates termination of the gesture input or continuation of the gesture input.

### FIELD OF THE INVENTION

Embodiments of the present invention relate to user input. In particular, they relate to gesture input using an optical user input device.

### BACKGROUND TO THE INVENTION

Some electronic devices comprise an optical user input device that enables a user to input information. The optical user input device comprises an optical emitter and an optical sensor. A user may input information into the electronic device by swiping his finger across an outer surface of the optical user input device, such that light emitted from the optical emitter is reflected by the moving finger and into the optical sensor.

### BRIEF DESCRIPTION OF VARIOUS EMBODIMENTS OF THE INVENTION

According to various, but not necessarily all, embodiments of the invention there is provided a method, comprising: detecting first information, indicating that a first action is to be performed, from an optical user input device, the first information being provided by the optical user input device in response to gesture input from a user; detecting further information from an input device; and using the further information to disambiguate, subsequent to detection of the first information, second information provided by the optical user input device to determine whether the second information indicates termination of the gesture input or continuation of the gesture input.

The gesture input may comprise performing a first user action over a first period of time, and performing a second user action over a second period of time. The first information may be detected in response to the first user action, and the second information may be detected in response to the second user action. The second period of time may immediately follow the first period of time. The first user action may involve movement of a user digit, and the second user action may involve holding the user digit substantially stationary.

The first user action may be performed by swiping a user digit across an outer surface of the optical user input device. The second user action may be performed by holding the user digit in a substantially stationary position on the outer surface of the optical user input, after the user digit has been swiped.

The first action may be performed by a processor in response to detecting the first information. The processor may, in response to determining that the second information indicates continuation of the first action, continue to perform the first action without a hiatus.

The optical user input device may comprise an optical emitter and an optical sensor. The optical sensor may provide the first information in response to detecting light emitted from the optical emitter.

The gesture input may be provided by a user digit. The further information may be used to disambiguate the second information in order to determine whether the second information was provided in response to the optical sensor detecting light emitted from the optical emitter and reflected from the user digit, or provided in response to the optical sensor detecting ambient light.

The input device may be an ambient light sensor, different to the optical user input device. The further information may be used to disambiguate the second information by determining whether the second information is substantially different to the further information, and if the second information is substantially different to the further information, the second information may be considered to indicate continuation of the gesture input.

The further information may be used to disambiguate the second information by adjusting the sensitivity of the optical sensor, such that following adjustment, the optical sensor provides second information in the form of a first output in response to detecting light emitted by the optical emitter, and second information in the form of a second output, in response to detecting ambient light.

The input device may be a proximity detector. The further information may indicate the proximity of a user digit to the optical input device when the second information is provided by the optical input device.

The optical user input device may be the input device. The further information may be used to disambiguate second information by determining whether the further information is different to the second information.

The optical user input device may be comprised in a navigation key and the first action may be a navigation action.

According to various, but not necessarily all, embodiments of the invention there is provided an apparatus, comprising: a first processor interface configured to receive first information, indicating that a first action is to be performed, from an optical user input device, the first information being provided by the optical user input device in response to gesture input from a user, and configured to receive second information, subsequent to the first information; a second processor interface configured to receive further information from an input device; and functional processing circuitry configured to use the further information to disambiguate the second information, in order to determine whether the second information is indicative of termination of the gesture input or continuation of the gesture input.

The gesture input may comprise performing a first user action over a first period of time, and performing a second user action over a second period of time. The first processor interface may be configured to detect the first information in response to the first user action, and configured to detect the second information in response to the second user action. The second period of time may immediately follow the first period of time. The first user action may involve movement of a user digit, and the second user action may involve holding the user digit substantially stationary.

The first user action may be performed by swiping a user digit across an outer surface of the optical user input device, and the second user action may be performed by holding the user digit in a substantially stationary position on the outer surface of the optical user input, after the user digit has been swiped.

The optical user input device may comprise an optical emitter and an optical sensor. The first information may be provided by the optical sensor in response to detecting light emitted from the optical emitter.

The gesture input may be provided by a user digit. The functional processing circuitry may be configured to use the further information to disambiguate the second information in order to determine whether the second information was provided in response to the optical sensor detecting light emitted from the optical emitter and reflected from the user digit, or provided in response to the optical sensor detecting ambient light.

The input device may be an ambient light sensor, different to the optical user input device.

The input device may be a proximity detector. The further information may indicate the proximity of a user digit to the optical input device when the second information is provided by the optical input device.

The optical user input device may be the input device. The second processor interface may be the first processor interface. The further information may be used to disambiguate second information by determining whether the further information is different to the second information.

According to various, but not necessarily all, embodiments of the invention there is provided a computer program comprising instructions which, when executed by a processor, enable: detecting first information, indicating that a first action is to be performed, from an optical user input device, the first information being provided by the optical user input device in response to gesture input from a user; detecting further information from an input device; and using the further information to disambiguate, subsequent to detection of the first information, second information provided by the optical user input device to determine whether the second information indicates termination of the gesture input or continuation of the gesture input.

The gesture input may comprise performing a first user action over a first period of time, and performing a second user action over a second period of time. The first information may be detected in response to the first user action, and the second information may be detected in response to the second user action. The second period of time may immediately follow the first period of time. The first user action may involve movement of a user digit, and the second user action may involve holding the user digit substantially stationary.

The first user action may be performed by swiping a user digit across an outer surface of the optical user input device. The second user action may be performed by holding the user digit in a substantially stationary position on the outer surface of the optical user input, after the user digit has been swiped.

According to various, but not necessarily all, embodiments of the invention there is provided an apparatus, comprising: means for detecting first information, indicating that a first action is to be performed, from an optical user input device, the first information being provided by the optical user input device in response to gesture input from a user; means for detecting further information from an input device; and means for using the further information to disambiguate, subsequent to detection of the first information, second information provided by the optical user input device to determine whether the second information indicates termination of the gesture input or continuation of the gesture input.

According to various, but not necessarily all, embodiments of the invention there is provided an apparatus, comprising: a first processor interface configured to receive first information, indicating that a first action is to be performed, from an optical user input device, the first information being provided by the optical user input device in response to a user beginning gesture input by swiping a digit across the optical user input device; a second processor interface configured to receive further information from an input device; and functional processing circuitry configured to analyze the further information in order to determine whether the further information is indicative of the user continuing the gesture input, after swiping the digit, by the user holding the digit substantially stationary.

### BRIEF DESCRIPTION OF THE DRAWINGS

For a better understanding of various examples of embodiments of the present invention reference will now be made by way of example only to the accompanying drawings in which:

FIG. 1 illustrates a first schematic of an apparatus;

FIG. 2 illustrates a second schematic of an apparatus;

FIG. 3 illustrates the front of an apparatus;

FIG. 4 illustrates a method;

FIG. 5 illustrates a third schematic of an apparatus; and

FIG. 6 illustrates an intensity-time graph.

### DESCRIPTION OF VARIOUS EMBODIMENTS OF THE INVENTION

The Figures illustrate a method, comprising: detecting first information 32, indicating that a first action is to be performed, from an optical user input device 18, the first information 32 being provided by the optical user input device 18 in response to gesture input from a user; detecting further information 36 from an input device 20; and using the further information 36 to disambiguate second information 34, subsequent to detection of the first information 32, provided by the optical user input device 18 to determine whether the second information 34 indicates termination of the gesture input or continuation of the gesture input.

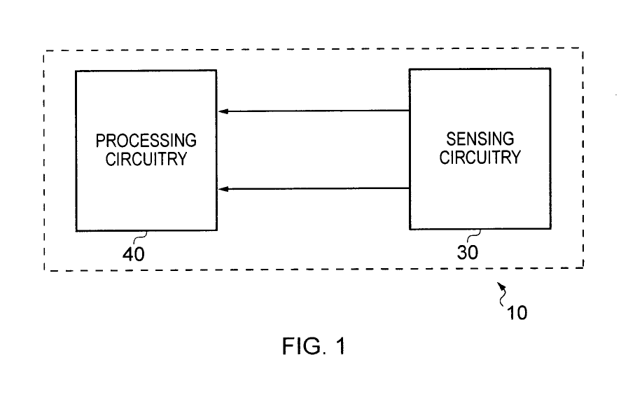

FIG. 1 illustrates an apparatus 10 comprising processing circuitry 40 and sensing circuitry 30. The apparatus 10 may be an electronic apparatus. In some embodiments of the invention, the apparatus is a hand portable electronic apparatus 10 such as a mobile telephone, a personal digital assistant or a personal music player.

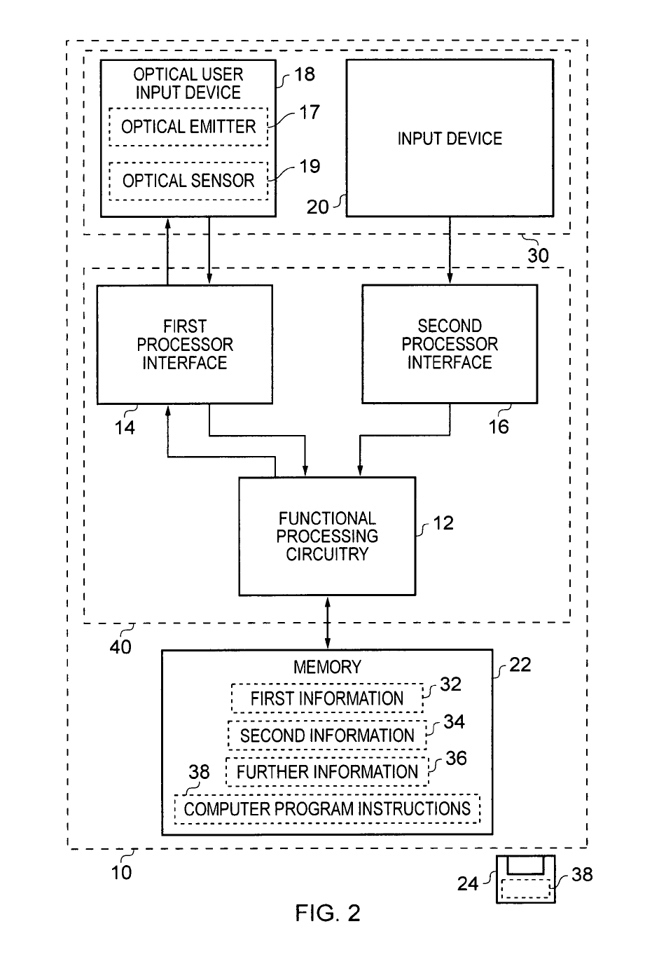

FIG. 2 illustrates a more detailed example of the apparatus 10. The apparatus 10 illustrated in FIG. 2 further comprises a memory 22. The processing circuitry 40 illustrated in FIG. 2 comprises a first processor interface 14, a second processor interface 16 and functional processing circuitry 12. The sensing circuitry 30 illustrated in FIG. 2 comprises an optical user input device 18 and an input device 20.

The elements 12, 14, 16, 18, 20 and 22 are operationally coupled and any number or combination of intervening elements can exist (including no intervening elements).

The optical user input device 18 comprises an optical emitter 17 and an optical sensor 19. The optical emitter 17 may, for example, be configured to emit electromagnetic waves. The emitted electromagnetic waves may, for instance, be infra-red light and/or visible light. The optical sensor 19 is configured to detect electromagnetic waves, such as infra-red light and/or visible light, emitted by the optical emitter 17. The optical sensor 19 is configured to provide an input to the functional processing circuitry 12 via the first processor interface 14. The functional processing circuitry 12 may be configured to provide an output to optical user input device 18 via the first processor interface 14. For example, the functional processing circuitry 12 may be configured to control the optical emitter 17 via the first processor interface 14.

The input device 20 is configured to provide an input to the functional processing circuitry 12 via the second processor interface 16. In some embodiments of the invention, the input device 20 may, for example, be a sensor that is configured to detect ambient electromagnetic waves. That is, electromagnetic waves that were not generated by the optical emitter 17. The input device 20 may, for instance, be an ambient optical sensor that is configured to detect visible light and/or infra-red light.

In some other embodiments of the invention, the input device 20 is a proximity detector that is configured to provide an output to the functional processing circuitry 12 in response to detecting that an aspect of a user (e.g. a user digit) is close to the optical user input device 18. The proximity detector may, for example, be a capacitance touch switch.

Implementation of the processing circuitry 40 can be in hardware alone (e.g. a circuit or a processor), have certain aspects in software including firmware alone or can be a combination of hardware and software (including firmware). In some embodiment of the invention, the processing circuitry 40 is local to the optical user input device 18. In some other embodiments of the invention, the processing circuitry 40 is the central processor in the apparatus 10. In other, alternative embodiments, some the processing circuitry 40 is local to the optical user input device 18, and some of the processing circuitry 40 is part of the central processor of the apparatus 10.

The processing circuitry 40 may be implemented using instructions that enable hardware functionality, for example, by using executable computer program instructions in a general-purpose or special-purpose processor that may be stored on a computer readable storage medium (e.g. disk, memory etc) to be executed by such a processor.

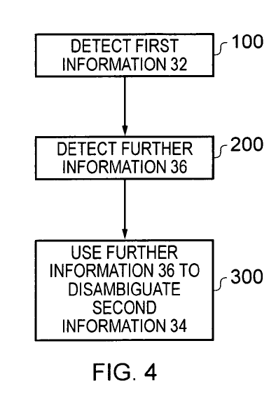

The processing circuitry 40 is configured to read from and write to the memory 22. The memory 22 stores computer program instructions 38 that control the operation of the apparatus 10 when loaded into the processing circuitry 40. The computer program instructions 38 provide the logic and routines that enables the apparatus 10 to perform the method illustrated in FIG. 4. The processing circuitry 40 by reading the memory 22 is able to load and execute the computer program instructions 38.

The computer program instructions 38 may arrive at the apparatus 10 via any suitable delivery mechanism 24. The delivery mechanism 24 may be, for example, a computer-readable storage medium, a computer program product, a memory device, a record medium such as a CD-ROM or DVD, or an article of manufacture that tangibly embodies the computer program instructions 38. The delivery mechanism 24 may be a signal configured to reliably transfer the computer program instructions 38. The apparatus 10 may propagate or transmit the computer program instructions 38 as a computer data signal.

Although the memory 22 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or ‘a computer’, ‘a processor’, ‘processing circuitry’ or ‘functional processing circuitry’ etc. should be understood to encompass not only computers having different architectures such as single/multi-processor architectures and sequential (e.g. Von Neumann)/parallel architectures but also specialized circuits such as field-programmable gate arrays (FPGA), application specific circuits (ASIC), signal processing devices and other devices. References to computer program instructions, code etc. should be understood to encompass software for a programmable processor or firmware such as, for example, the programmable content of a hardware device whether instructions for a processor, or configuration settings for a fixed-function device, gate array or programmable logic device etc.

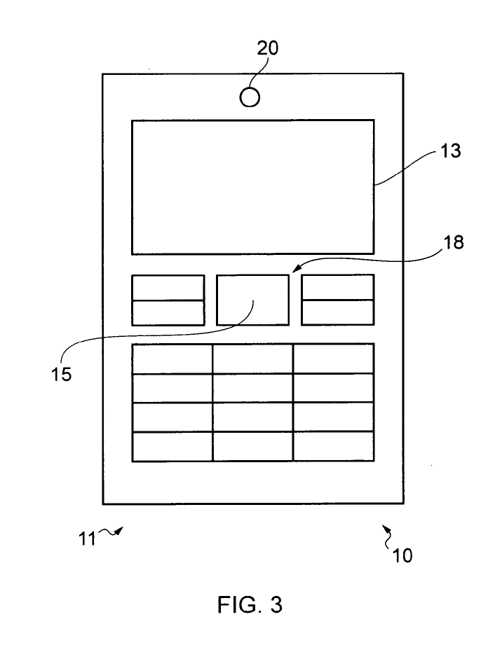

FIG. 3 illustrates an outer front surface 11 of one example of the apparatus 10, in accordance with a first embodiment of the invention. In the first embodiment of the invention, the input device 20 is an ambient optical sensor. The ambient optical sensor 20 is illustrated as being located on the outer front surface 11 of the apparatus 10, near to a display 13.

The ambient optical sensor 20 is configured to detect the amount of ambient visible light and/or infra-red light that is present at the outer front surface 11 of the apparatus 10. The functional processing circuitry 12 may, for example, be configured to adjust the brightness of the display 13 on the basis of an input provided by the ambient optical sensor 20, in order to enable a user to see images or text on the display 13 more easily.

FIG. 3 illustrates an outer surface 15 of the optical user input device 18. The optical user input device 18 may, for example, be a five-way navigation key. The five-way navigation key may enable a user to scroll through menu items in the up, down, left and right directions. The navigation key may enable a user to select a menu item by depressing the navigation key.

A user may navigate through menus by providing a gesture input at the outer surface 15 of the optical user input device 18. For example, in order to scroll upwards through a menu, a user may swipe a digit (a finger or a thumb) in an upwards fashion across the outer surface 15. In order to scroll rightwards, downwards or leftwards through a menu, a user may swipe a digit in a rightwards, downwards or leftwards fashion, respectively.

The optical emitter 17 is configured to emit visible and/or infra-red light through the outer surface 15 and towards a user digit. The optical sensor 19 is configured to detect visible and/or infra-red light that has been emitted by optical emitter 17 and subsequently reflected by the user digit towards the optical sensor 19.

The optical emitter 17 emits visible and/or infra-red light towards the user digit as it is swiped across the outer surface 15 of the optical user input device 18. The digit reflects the emitted light towards the optical sensor 19 as it is swiped. The light reflected from the moving digit provides a time-varying image at the optical sensor 19. The optical sensor 19 detects the time-varying image and responds by providing time-varying first information 32 to the functional processing circuitry 12 via the first processor interface 14.

The functional processing circuitry 12 determines the direction of the digit swipe by analyzing the time-varying first information 32 provided by the optical sensor 19. Once the direction has been determined, the functional processing circuitry 12 performs the action associated with the determined direction.

Referring now to FIG. 4, a user begins gesture input by swiping a digit across the outer surface 15 of the optical user input device 18 in an upwards fashion, over a first period of time. The swipe action can be considered to be “a first user action” in the gesture input.

At block 100 of FIG. 4, the first processor interface 14 detects first information 32 that is provided by the optical sensor 19 in response to the digit swipe.

The functional processing circuitry 12 analyzes the first information 32 and determines from the analysis that an upwards swipe was made by the user. The functional processing circuitry 12 responds by performing an action associated with the upwards swipe. For example, an upwards swipe may relate to movement of a cursor in an upwards direction. The functional processing circuitry 12 may, in that instance, respond by moving a cursor on the display 13 so that the cursor changes from highlighting a first icon on the display 13 to highlighting a second icon on the display 13, positioned above the first icon.

The user then continues the gesture input by holding the swiped digit substantially stationary, in a position on the outer surface 15 of the optical user input device 18. This can be considered to be “a second user action” in the gesture input.

The swiped digit is held substantially stationary for a second period of time. The second period of time immediately follows the first period of time.

While the user's digit is held substantially stationary on the outer surface 15 of the optical user input device 18, it reflects light emitted by the optical emitter 17 into the optical sensor 19. The reflected light produces a static image at the optical sensor 19. The optical sensor 19 responds to the static image by providing second information 34 to the functional processing circuitry 12. The second information 34 provides an indication of the intensity of light in the static image. The second information 34 is detected by the first processor interface 14, which provides it to the functional processing circuitry 12.

A problem exists in that it may not be apparent to the functional processing circuitry 12 from the second information 34 that the static image at the optical sensor 19 was provided by light that was reflected from a user digit. For example, in an alternative scenario, the user may have terminated the gesture input after swiping the digit, by removing the digit from the optical user input device 18. However, even though the digit has been removed, a static image may be provided at the optical sensor 19 by ambient light.

At block 200 of FIG. 4, the second processor interface 16 detects further information 36 that is provided by the ambient optical sensor 20. The further information 36 provides an indication of the intensity of ambient (visible and/or infra-red) light that is detected by the ambient optical sensor 20.

At block 300 of FIG. 4, the functional processing circuitry 12 uses the further information 36 to disambiguate the second information 34. In this first embodiment of the invention, the functional processing circuitry 12 disambiguates the second information 34 by comparing the further information 36 from the ambient optical sensor 20 with the second information 34 from the optical sensor of the optical input device 18.

In this example, the user digit is held substantially stationary at the optical user input device 18 following the digit swipe. The intensity of the light reflected from the user digit towards the optical sensor 19 of the optical user input device 18 is likely to be different to that falling upon the ambient optical sensor 20.

The functional processing circuitry 12 compares the further information 36 with the second information 34. It determines that the intensity of light falling upon the ambient optical sensor 20 is different to that falling on the optical user input device 18. The functional processing circuitry 12 therefore determines that a user digit is being held substantially stationary at the optical user input device 18.

In response to making the determination, the functional processing circuitry 12 responds by continuing to perform the first action without a hiatus. In this example, the first action was described as being upwards movement of a cursor. The functional processing circuitry 12 therefore continues to move the cursor upwards, from the second icon in the menu to a third icon, positioned above the second icon.

The ambient optical sensor 20 and the optical sensor 19 of the optical user input device 18 may continue to provide further information 36 and second information 34 respectively on a periodic basis to the functional processing circuitry 12. The functional processing circuitry 12 may continue to perform the first action (upwards movement of the cursor), until it determines from a comparison of the further information 36 and the second information 34 that the intensity of light falling upon the ambient optical sensor 20 and the optical sensor 19 of the optical user input device 18 is different.

If the user had terminated the gesture input by removing the digit from the outer surface 15 of the optical user input device 18 after swiping the digit, the further information 36 and the second information 34 would indicate that the intensity of light falling on the ambient optical sensor 20 and intensity of light falling on the optical sensor 19 of the optical user input device 18 were substantially the same.

In that case, after comparing the further information 36 and the second information 34, the functional processing circuitry 12 would have determined that the gesture input had been terminated by the user after the digit swipe. Consequently, the first action would not have been continued by the functional processing circuitry 12. That is, in the context of the above example, the functional processing circuitry 12 would not have moved the cursor from the second icon to the third icon.

Embodiments of the invention enable a user to indicate that he wishes the apparatus 10 to continue performing a first action by holding a digit at the optical user input device 18, after the digit has been swiped across an outer surface 15 of the optical user input device 18. This advantageously provides a comfortable way in which to navigate through information presented on the display 13.

The first embodiment described above is just one possible implementation. In a second embodiment of the invention, the functional processing circuitry 12 uses the further information 36 provided by the ambient optical sensor 20 in a different manner to disambiguate the second information 34.

In the second embodiment, the functional processing circuitry 12 analyses the further information 36 to determine the intensity of light falling upon the ambient optical sensor 20. The functional processing circuitry 12 then sets the sensitivity of the optical sensor 19 of the optical user input device 18 and the output of the optical emitter 17, in dependence upon the analysis. For example, in response to determining that the intensity of light falling upon the ambient optical sensor is relatively high, the functional processing circuitry 12 may increase the intensity of light that is output by the optical emitter 17 and reduce the sensitivity of the optical sensor 19.

The reduction in the sensitivity of the optical sensor 19 increases the intensity of light that is required to ‘trigger’ the optical sensor 19. The sensitivity is reduced in such a way that the ambient light having the intensity indicated in the further information 36 will not trigger the optical sensor 19. The intensity of light output by the optical emitter 17 is increased in such a way that light which is emitted by optical emitter 17 and reflected by a user digit is expected to trigger the optical sensor 19.

Following the reduction in the sensitivity of the optical sensor 19 and the increase in the output intensity of the optical emitter 17, if the second information 34 indicates that the optical sensor 19 has been triggered (in the second period of time, following the digit swipe), the functional processing circuitry 12 determines that the user's gesture input has been continued, and therefore continues to perform the first action. If the second information 34 indicates that the optical sensor 19 has not been triggered, the functional processing circuitry 12 determines that the user's gesture input has been terminated, and ceases to perform the first action.

The third embodiment of the invention differs from the first and second embodiments of the invention in that the input device 20 is a proximity detector (such as a capacitance touch sensor), rather than an ambient optical sensor 20.

In the third embodiment, in the second period of time, after the user has swiped a digit to instruct the apparatus 10 to perform the first action, the proximity detector 20 detects whether the user digit is still present at the outer surface 15 of the optical user input device 18. It then provides further information 36 to the functional processing circuitry 12 via the second processor interface 16, indicating whether the user digit is still present.

If the further information 36 indicates that the user digit is still present, the functional processing circuitry 12 continues to perform the first action, as described in relation to the first embodiment above. If the further information indicates that the user digit is no longer present, the functional processing circuitry 12 ceases to perform the first action.

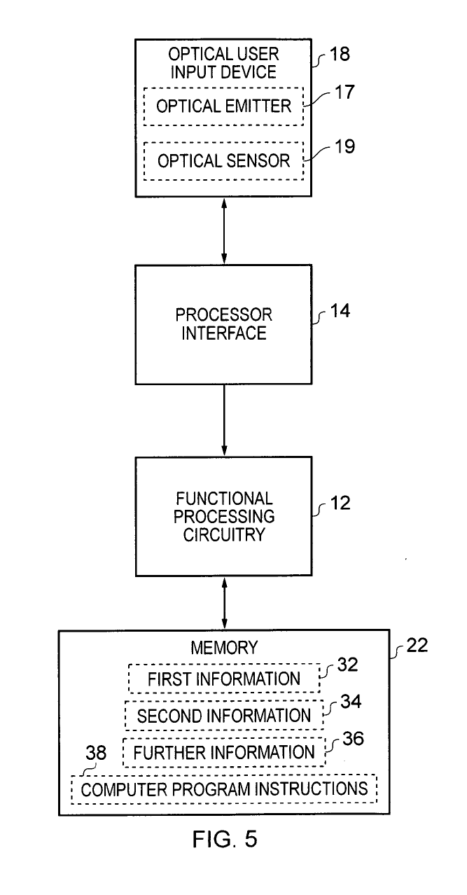

FIG. 5 illustrates a schematic of the apparatus 10 according to a fourth embodiment of the invention. The fourth embodiment differs from the first, second and third embodiments in that the apparatus 10 does not comprise an input device 20 in addition to the optical user input device 18 and in that it does not comprise the second processor interface 16.

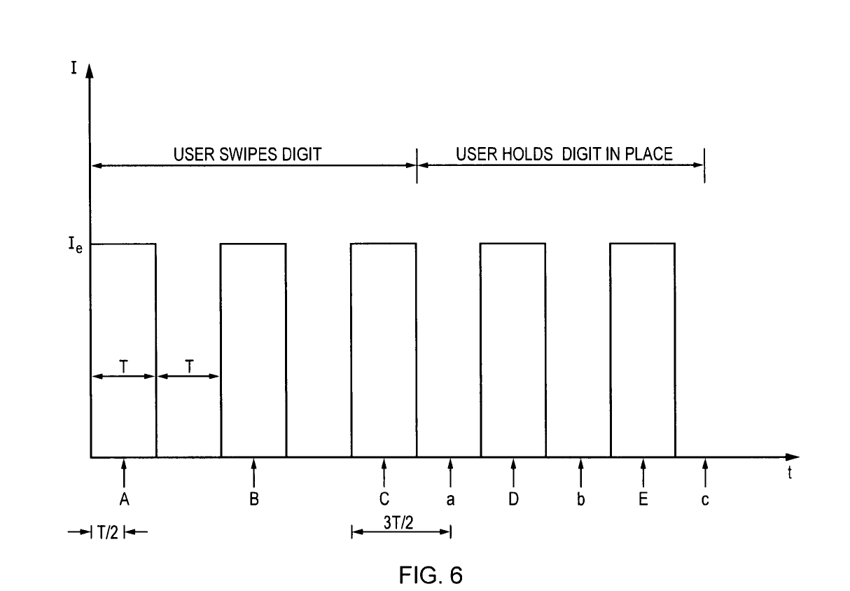

In the fourth embodiment, the optical emitter 17 of the optical user input device 18 emits modulated (visible and/or infra-red) light. FIG. 6 illustrates an example of an intensity-time graph for light emitted by the optical emitter 17. The light emitted by the optical emitter 17 is illustrated as providing an output intensity of lₑ for a period of time T, followed by a period of time T where the output intensity is zero. This pattern is repeated over time. FIG. 6 is an intensity-time graph for the optical emitter 17, illustrating a repeating step function with a frequency of 2T.

In this example, the processor interface 14 begins by detecting inputs from the optical sensor 19 periodically, according to a first detection pattern having a frequency of 2T. Arrows A, B, C, D and E illustrated in FIG. 6 indicate the times at which the processor interface 14 detects inputs from the optical sensor 19 according to the first detection pattern.

The detection times A, B, C, D and E in the first detection pattern are offset from the points at which the intensity output is increased by the optical emitter 17 from zero to Iₑ by +T/2. The first detection pattern is defined such that the processor interface 14 detects inputs from the optical sensor 19 at times that reflected light is expected to be present at the optical sensor 19, if a user digit were present at the outer surface 15 of the optical user input device 18.

If the optical sensor 19 detects reflected light, it provides a non-zero input to the processor interface 14. If the optical sensor 19 does not detect reflected light, it provides a zero input to the processor interface 14. Therefore, if a user digit is present at the outer surface 15 of the optical user input device 18, the input provided to the processor interface 14 by the optical sensor 19 at detection times A, B, C, D and E will be non-zero.

A user begins gesture input by swiping a digit across the outer surface 15 of the optical user input device 18, over a first period of time. As the user's digit is moved across the outer surface 15, light emitted periodically by the optical emitter 17 is reflected towards the optical sensor 19. The optical sensor 19 responds by providing periodically varying its input to the processor interface 14 between non-zero and zero, over time. The processor interface 14 detects the inputs from optical sensor 19 at detection times A, B and C, all of which are non-zero. These inputs are provided to the functional processing circuitry 12 by the processor interface 14.

The inputs provided by the optical sensor 19 at detection times A, B and C can collectively be considered to be first information 32. The functional processing circuitry 12 compares the inputs provided by the optical sensor 19 at detection times A, B and C with one another in order to determine whether a user digit has swiped and to determine the direction of the swipe.

Once a swipe is detected, the functional processing circuitry 12 performs a first action associated with the direction of the swipe. It also controls the processor interface 14 to begin a second detection pattern. The second detection pattern has a frequency of 2T. Arrows a, b, and c illustrated in FIG. 6 indicate the times at which the processor interface 14 detects inputs from the optical sensor 19 according to the second detection pattern.

The detection times a, b, c in the second detection pattern are offset from the points at which the intensity output is increased by the optical emitter 17 from zero to Iₑ by +3T/2. The purpose of the second detection pattern is to detect inputs from the optical sensor 19 at times that reflected light is not expected to be present at the optical sensor 19 if a user digit is present at the outer surface 15 of the optical user input device 18 (i.e. because no light is being emitted by the optical emitter 17 at these times).

After swiping the digit, over the first period of time, the user continues gesture input by holding the digit substantially stationary at the outer surface 15 of the optical user input device 18, over a second period of time. The second period of time immediately follows the first period of time.

As light is periodically emitted by the optical emitter 17, it is reflected by the user's stationary digit and subsequently detected at the optical sensor 19. The optical sensor 19 responds by periodically varying its input to the first processor interface 14 between non-zero and zero, over time.

The inputs detected during the second period of time using the first detection pattern can be considered to be second information 34. The second information 34 therefore includes the inputs detected at detection times D and E.

The inputs detected during the second period of time using the second detection pattern can be considered to be further information 36. The further information therefore includes the inputs detected at detection times a, b and c.

In order to determine whether a user is continuing gesture input after the digit swipe, the functional processing circuitry 12 uses the further information 36 to disambiguate the second information 34.

In this example, the user has continued gesture input by holding the digit substantially stationary at the outer surface 15 of the optical user input device 18. Consequently, the second information 34 comprises a plurality of non-zero inputs from the optical sensor 19 and the further information 36 comprises a plurality of zero inputs from the optical sensor 19.

The functional processing circuitry 12 analyses the further information 36 to determine whether it includes similar inputs to the second information 34. As the further information 36 comprises a plurality of zero inputs and the second information 34 includes a plurality of different, non-zero inputs, it is apparent to the functional processing circuitry 12 that a user digit is present at the outer surface 15 of the optical user input device 18 which is reflecting the modulated light being emitted by the optical emitter 17. The functional processing circuitry 12 therefore continues to perform the first action without a hiatus.

Consider a situation where gesture input is terminated by the user by removing the digit from the outer surface 15 of the optical user input device 18 after swiping the digit. After the swipe has been completed, light emitted by optical emitter 17 is not reflected towards the optical sensor 19, because the user's digit is no longer present.

In the absence of the user digit, the optical sensor 19 may or may not detect ambient light. If the ambient light level is sufficient to trigger the optical sensor 19, the inputs provided to the processor interface 14 at the detection times D and E in the first detection pattern will be non-zero. If not, the inputs provided to the processor interface 14 at the detection times D and E in the first detection pattern will be zero.

The ambient light level is likely to remain relatively constant over the time period over which the light emitted by the optical emitter 17 is modulated. The inputs provided by the optical sensor 19 at the detection times a, b and c in the second detection pattern are therefore likely to be the same or very similar to the inputs provided by the optical sensor 19 at the detection times D, E in the first detection pattern.

Consequently, if the functional processing circuitry 12 determines that the further information 36 includes the same or similar inputs to the second information 34, it concludes that a user digit is no longer present at the outer surface 15 of the optical user input device 18. The functional processing circuitry 12 determines that the gesture input has been terminated and ceases to perform the first action.

The blocks illustrated in FIG. 4 may represent steps in a method and/or sections of code in the computer program instructions 38. The illustration of a particular order to the blocks does not necessarily imply that there is a required or preferred order for the blocks and the order and arrangement of the block may be varied. Furthermore, it may be possible for some steps to be omitted.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. A method, comprising:
detecting first information, indicating that a first action is to be performed, from an optical user input device, the first information being provided by the optical user input device in response to gesture input from a user;
detecting further information from an input device; and
using the further information to disambiguate, subsequent to detection of the first information, second information provided by the optical user input device to determine whether the second information indicates termination of the gesture input or continuation of the gesture input.

2. A method as claimed in claim 1, wherein the gesture input comprises performing a first user action over a first period of time, and performing a second user action over a second period of time.

3. (canceled)

4. (canceled)

5. A method as claimed in claim 2, wherein the first user action involves movement of a user digit, and the second user action involves holding the user digit substantially stationary.

6. (canceled)

7. A method as claimed in claim 1, wherein in response to detecting the first information, the first action is performed by a processor, and in response to determining that the second information indicates continuation of the first action, continuing to perform the first action without a hiatus.

8. A method as claimed in claim 1, wherein the optical user input device comprises an optical emitter and an optical sensor, and the optical sensor provides the first information in response to detecting light emitted from the optical emitter.

9. A method as claimed in claim 8, wherein the gesture input is provided by a user digit, and the further information is used to disambiguate the second information in order to determine whether the second information was provided in response to the optical sensor detecting light emitted from the optical emitter and reflected from the user digit, or provided in response to the optical sensor detecting ambient light.

10. A method as claimed in claim 1, wherein the input device is an ambient light sensor, different to the optical user input device.

11. (canceled)

12. (canceled)

13. A method as claimed in claim 1, wherein the gesture input is provided by a user digit, the input device is a proximity detector, and the further information indicates the proximity of a user digit to the optical input device when the second information is provided by the optical input device.

14. A method as claimed in claim 1, wherein the optical user input device is the input device, and the further information is used to disambiguate second information by determining whether the further information is different to the second information.

15. (canceled)

16. An apparatus, comprising:
processing circuitry; and
at processing circuitry; and
at least one memory storing a computer program comprising instructions that are configured to, with the processing circuitry, cause the apparatus to perform at least the following:
detecting first information, indicating that a first action is to be performed, from an optical user input device, the first information being provided by the optical user input device in response to gesture input from a user,
detecting further information from an input device; and
using the further information to disambiguate, subsequent to detection of the first information, the second information provided by the optical user input device to determine whether the second information is indicative of termination of the gesture input or continuation of the gesture input.

17. An apparatus as claimed in claim 16, wherein the gesture input comprises performing a first user action over a first period of time, and performing a second user action over a second period of time.

18. (canceled)

19. (canceled)

20. An apparatus as claimed in claim 17, wherein the first user action involves movement of a user digit, and the second user action involves holding the user digit substantially stationary.

21. (canceled)

22. An apparatus as claimed in claim 17, wherein the optical user input device comprises an optical emitter and an optical sensor, and the first information is provided by the optical sensor in response to detecting light emitted from the optical emitter.

23. (canceled)

24. An apparatus as claimed in claim 16, wherein the input device is an ambient light sensor, different to the optical user input device.

25. An apparatus as claimed in claim 16, wherein the gesture input is provided by a user digit, the input device is a proximity detector, and the further information indicates the proximity of a user digit to the optical input device when the second information is provided by the optical input device.

26. An apparatus as claimed claim 16, wherein the optical user input device is the input device, the second processor interface is the first processor interface, and the further information is used to disambiguate second information by determining whether the further information is different to the second information.

27. A non-transitory computer readable medium storing a computer program comprising instructions configured to working with processing circuitry, cause at least the following to be performed:
detecting first information, indicating that a first action is to be performed, from an optical user input device, the first information being provided by the optical user input device in response to gesture input from a user;
detecting further information from an input device; and
using the further information to disambiguate, subsequent to detection of the first information, second information provided by the optical user input device to determine whether the second information indicates termination of the gesture input or continuation of the gesture input.

28. A computer program as claimed in claim 27, wherein the gesture input comprises a performing a first user action over a first period of time, and performing a second user action over a second period of time.

29. (canceled)

30. (canceled)

31. A computer program as claimed in claim 28, wherein the first user action involves movement of a user digit, and the second user action involves holding the user digit substantially stationary.

32. (canceled)

33. (canceled)

34. An apparatus as claimed in claim 16, wherein the apparatus is a hand portable electronic device that further comprises the optical user input device.
